(19) United States
(12) Patent Application Publication
(10) Pub. No.: US 2014/0029747 A1
(43) Pub. Date: Jan. 30, 2014

(54) SYSTEM AND METHOD FOR TRANSCODING CONTENT

(71) Applicants: John P. Kamieniecki, Lafayette Hill, PA (US); Tat Keung Chan, San Diego, CA (US); Kevin T. Chang, Doylestown, PA (US); Alexander Medvinsky, San Diego, CA (US)

(72) Inventors: John P. Kamieniecki, Lafayette Hill, PA (US); Tat Keung Chan, San Diego, CA (US); Kevin T. Chang, Doylestown, PA (US); Alexander Medvinsky, San Diego, CA (US)

(73) Assignee: GENERAL INSTRUMENT CORPORATION, Horsham, PA (US)

(21) Appl. No.: 13/557,595

(22) Filed: Jul. 25, 2012

(51) Int. Cl. G06F 21/24

(52) U.S. Cl. 380/28

(57) ABSTRACT

A system is provided for use with secure content in a first format. The system includes a conditional access device, a transcoding device and a media processor. The conditional access device is operable to receive the secure content and can generate a second secure content based on the secure content. The conditional access device can further provide the second secure content to the transcoding device. The transcoding device can transcode the second secure content into transcoded content of a second format, can secure the transcoded content as secure transcoded content and can provide the secure transcoded content to the media processor

### FIELD OF THE INVENTION

The present invention relates to transcoding media content over an interface, and in particular to transcoding media content into secure transcoded media content to be provided to a media processor.

### BACKGROUND

In digital cable systems, it is desirable to prevent the unauthorized access of certain content as it crosses from a conditional access device, a non-limiting example of which includes a Cable Card, to a Host (set-top terminal) on the Card-Host interface. Cablelab's “CableCard Copy Protection 2.0 Specification” (OP-SP-CCCP2.0) defines procedures and methods for a compliant Multi-stream Cable Card (M-card) and a host media processor (Host) to securely communicate and negotiate encryption keys needed for providing copy protection of high value content across the M-card-Host Cable Card InterFace (CCIF). These procedures authenticate the M-card and Host pair and bind them together using a Diffie-Hellman key exchange. This exchange is based in part upon Cablelab's Certificate Authority based x.509 certificates that are stored in the M-card and the Host. In addition to securing the content connection between M-card and the Host for High Value media content, it also provides for conditional access (CA) system validation and revocation in the event of a device/product compromise.

A CA system provides a private way to communicate command/control information to the M-card including validation of the M-card and Host combination. An M-card and the Host complete the binding process after mutual authentication and the validation by the CA system. In the event the integrity of a Host becomes compromised, the CA system also provides a way to communicate a Certificate Revocation List (CRL) to the M-card, which can in turn disable the high value media content exchange to a compromised Host. A properly bound M-card and Host will jointly compute Copy Protection (CP) keys as necessary and according to OP-SP-CCCP2.0 specification in order to secure high value media content as it flows from the M-card to the Host.

FIG. 1 illustrates a block diagram for a prior art set top box (STB) 100.

As illustrated in the figure, STB 100 includes a connector 102, a diplex filter 104, an out-of-band (OOB) modulator 106, an OOB demodulator 108, an M-Card 110, an in-band (IB) tuner 112, an IB tuner 114, a host media processor 116, a flash memory 118, a system DRAM 120, a hard disk drive (HDD) 122, a transcoder 123, a transcoder DRAM 124, and peripheral devices 125.

In this example, each of diplex filter 104, OOB modulator 106, OOB demodulator 108, M-Card 110, IB tuner 112, IB tuner 114, host media processor 116, flash memory 118, system DRAM 120, HDD 122, transcoder 123, and transcoder DRAM 124 are distinct devices. However, in other embodiments, at least two of diplex filter 104, OOB modulator 106, OOB demodulator 108, M-Card 110, IB tuner 112, IB tuner 114, host media processor 116, flash memory 118, system DRAM 120, HDD 122, transcoder 123, and transcoder DRAM 124 may be combined as a unitary device. Further, in some embodiments, at least one of diplex filter 104, OOB modulator 106, OOB demodulator 108, M-Card 110, IB tuner 112, IB tuner 114, host media processor 116, flash memory 118, system DRAM 120, HDD 122, transcoder 123, and transcoder DRAM 124 may be implemented as non-transient, tangible computer-readable media for carrying or having computer-executable instructions or data structures stored thereon. Such non-transient, tangible computer-readable media can be any available media that can be accessed by a general purpose or special purpose computer. Non-limiting examples of non-transient, tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (hardwired and/or wireless, or a combination of hardwired or wireless) to a computer, the computer properly views the connection as a non-transient, tangible computer-readable media computer-medium. Thus, any such connection is properly termed a non-transient, tangible computer-readable medium. Combinations of the above should also be included within the scope of non-transient, tangible computer-readable media.

Diplex filter 104 is operable to receive a broadband signal 126 from connector 102 and an OOB modulated signal 128 from OOB modulator 106. Broadband signal 126 may be an input signal from a cable company or a satellite, available via connector 102. Diplex filter 104 performs frequency domain multiplexing between broadband signal 126, which may be a multiplex of IB downstream bound high frequency signals and OOB modulated signal 128, which may be an upstream bound low frequency signal. Downstream information provided by broadband signal 126 may include video, audio, multimedia and/or data.

OOB modulator 106 is operable to receive an OOB signal 132 from M-Card 110 and to provide OOB modulated signal 128 to diplex filter 104. OOB modulator 106 is also known as Return Path Transmitter (RPT), which is used to transmit the low frequency upstream information destined for the head-end server. Upstream information provided by OOB modulated signal 128 may include video, audio, multimedia, and/or data.

OOB demodulator 108 is operable to receive a diplex filter output signal 130 and to provide an OOB demodulated signal 134 to M-card 110. Traditionally, OOB demodulator 108 receives CA control information about the media content on a narrowband carrier, which it passes on to M-card 110.

M-Card 110 is operable to receive OOB demodulated signal 134, data input signal 138, and CPU interface signal 136. M-Card 110 is also operable to provide OOB signal 132, data output signal 140.

M-Card 110 receives and standardizes media access control messages from the head-end server via OOB demodulated signal 134 and forwards pertinent processed messages to host media processor 116 via interface signal 136. M-Card 110 performs any conditional access and decryption functions based on the media access control messages, which may contain information about configurations, authorizations, entitlements, etc. of the media content received by IB tuner 112 and IB tuner 114.

M-Card 110 receives CA encrypted media content via data input 138 from host media processor 116, and if authorized, decrypts the media content and passes it back to host media processor 116 via data output signal 140. If the copy protection rules are such that data output signal 140 needs to be protected then M-Card 110 may encrypt data output signal 140 for protection, otherwise data output signal 140 may not be encrypted.

CPU interface signal 136 is used for exchanging control information between M-Card 110 and host media processor 116.

IB tuner 112 and IB tuner 114 receive encrypted content from diplex filter 104. IB tuner 112 performs in-band tuning of diplex filter output signal 130 and provides a baseband signal 142 to host media processor 116. Similarly, IB tuner 114 performs in-band tuning of diplex filter output signal 130 and provides another baseband signal 144 to host media processor 116. There are only two tuners shown in FIG. 1, however, there may be any number of tuners connected to host media processor 116.

Host media processor 116 interfaces with M-Card 110 for a two-way communication using CPU interface signal 136. It receives encrypted media content from IB tuner 112 and IB tuner 114 and provides the encrypted media content via data input signal 138 to M-Card 110. Media content received from M-Card 110 via data output signal 140 may or may not be re-encrypted.

Host media processor 116 is operable to send data stream 158 to transcoder 123 and receive data stream 160 from transcoder 123. If host media processor 116 receives encrypted data from M-Card 110 it sends the encrypted data to transcoder 123. Transcoder 123 decrypts the contents, transcodes it, re-encrypts it, and sends it back to host media processor 116 via data stream 160. Host media processor 116 communicates with transcoder 123 via control interface signal 154.

Depending on the IP rights, host media processor 116 may store the media content on HDD 122 or provide it to peripheral devices 125 via peripheral interface 152. Note that there is a plurality of peripheral devices with their corresponding interfaces, however, they are grouped as a peripheral device 125 with a peripheral interface 152 for convenience. Host media processor 116 interfaces with flash memory 118 via an external bus interface signal 146. Host media processor 116 also interfaces with system DRAM 120 via a DRAM interface signal 148.

FIG. 2 illustrates a functional diagram for prior art STB 100.

FIG. 2 includes M-Card 110, host media processor 116, transcoder 123, a host certificate 204, a card certificate 208, and a cable head-end command and control portion 242. M-Card 110 further includes a CP processing portion 206, a CA decrypt portion 210, and a CP encrypt portion 212. Host media processor 116 further includes a CP processing portion 202, a CP decrypt portion 214, a private CP encrypt portion 216, an authentication and CP key exchange portion 222, a private certificate chain 226, and a private CP decrypt portion 232. Transcoder 123 further includes a private CP decrypt portion 218, an authentication and CP key exchange portion 220, a private certificate chain 224, a transcode portion 228 and a private CP encrypt portion 230.

CP processing portion 202, CP decrypt portion 214, private CP encrypt portion 216, and private CP decrypt portion 232 are functional elements that may be contained in a single device or separate devices. Those of skill in the art would appreciate that the functions performed by a single device may provide increased security. Further, in some embodiments at least one of CP processing portion 202 and CP decrypt portion 214 may be implemented as a non-transient, tangible computer-readable media for carrying or having computer-executable instructions or data structures stored thereon.

CP processing portion 206, CA decrypt portion 210, and CP encrypt portion 212 are functional elements that may be contained in a single device or separate devices. Those of skill in the art would appreciate that the functions performed by a single device may provide increased security. Further, in some embodiments at least one of CP processing portion 206, CA decrypt portion 210 and CP encrypt portion 212 may be implemented as non-transient, tangible computer-readable media for carrying or having computer-executable instructions or data structures stored thereon.

Private CP decrypt portion 218 and private CP encrypt portion 230 are functional elements that may be contained in a single device or separate devices. Those of skill in the art would appreciate that the functions performed by a single device may provide increased security. Further, in some embodiments at least one of private CP decrypt 218 and private CP encrypt portion 230 may be implemented as non-transient, tangible computer-readable media for carrying or having computer-executable instructions or data structures stored thereon.

Host certificate 204 and card certificate 208 represent the identity of host media processor 116 and M-Card 110, respectively. Initially, host certificate 204 is loaded into host media processor 116 and card certificate 208 is loaded into M-Card 110. Certificates may be loaded into these devices via a number of known ways.

Cable head-end command and control signal 242 is similar to 00B demodulated signal 134 and includes CA entitlement and a pairing function to validate the compatibility of M-Card 110 and host media processor 116. M-Card 110 and host media processor 116 mutually authenticate each other using mutual authentication and Diffie Hellman exchange information 234.

In operation, the Diffie Hellman method allows two entities to jointly establish a shared secret key over a communication link, without having any prior knowledge of each other. M-Card 110 and host media processor 116 jointly generate a CP key 236, which is used by CP encrypt portion 212 via an information signal 240 and passes it over to a CP encrypted content 248. Diffie Hellman exchange information 234 and CP key generation 236 together represent CPU interface signal 136.

CA decrypt portion 210 receives CA encrypted content 244 and it's associated IP rights from host media processor 116, which has been encrypted by any known encryption method. CA decrypt portion 210 provides an information signal with CA decrypted data 246 to CP encrypt portion 212 in order to instruct CP encrypt portion 212 whether or not CA decrypted data 246 needs to be re-encrypted based on associated IP rights. If CP encrypted content 248 has been encrypted, then it needs to be decrypted by CP decrypt portion 214, controlled by an information signal 238 provided by CP processing portion 202.

Host media processor 116 further encrypts the CP encrypted content using private CP encrypt portion 216. Private CP encrypt portion 216 receives CP encrypted content via signal 250 and provides private CP encrypted content to transcoder 123 via private CP encrypted content signal 252.

Transcoding of secure content will now be described.

Video format transcoding is a conversion of video content from one format into another format between different types of video devices. Video format transcoding is a valuable feature within set-top box (STB) architectures. Transcoding allows for contents to be broadcast in formats that are already in use, such as MPEG-2 (Moving Picture Experts Group-2), but then converted into an advanced format, such as MPEG-4 that allows for the content to consume less capacity on hard disk drives, in the case of Digital Video Recorder (DVR) applications, and consume less bandwidth on home networks, in the case of multi-room DVR, or other streaming applications. Other uses of transcoding include reformatting High Definition (HD) and Standard Definition contents into formats suitable to be viewed on mobile handsets with smaller screen sizes.

The OpenCable 2.0 Host specifications have a mandatory requirement for MPEG-2 video decode, but not MPEG-4/H.264. In order to support new and more efficient digital video encoding schemes, for example, MPEG-4, has raised a need for a transcoder in order to switch between different video formats.

Transcoder 123 decrypts the private CP encrypted content using private CP decrypt portion 218 to generate decrypted content 254. Transcoding portion 228 transcodes decrypted content 254 from a first format into a second format as transcoded content 256. Private CP encrypt portion 230 then encrypts the transcoded content 256 as private CP encrypted content 258. Private CP encrypt portion 230 then sends private CP encrypted content 258 back to host media processor 116. Private CP decrypt portion 232 receives private CP encrypt content 258 and then decrypts it.

In an embodiment, private security/authentication portion 220 receives a private certificate chain A 224 via signal 260. In an embodiment, private security/authentication portion 222 may additionally receive a private certificate from private certificate chain A 226 via signal 262. Private security/authentication portion 220 and private security/authentication portion 222 communicate with each other via CPU interface signals 264 and 266 in order to establish mutual authentication and secure CP exchange.

Another example of authenticating between a host media processor and a transcoder involves the secure ‘preloading’ of secret keys into the transcoder and the host media processor at the time of manufacture. With this type of authentication arrangement, the transcoder and the host media processor would thus be paired and may then securely communicate without the need to exchange certifications/keys. Accordingly, with this type of authentication arrangement, there would be no need for a secure CP exchange between transcoder 123 and host media processor 116, for example by way of CPU interface signal 266.

FIG. 3 is a timing diagram, illustrating the relative time of processes of M-Card 110, host media processor 116, and transcoder 123 of STB 100.

In, operation, as illustrated in FIG. 3, M-Card 110 and host media processor 116 are mutually authenticated as represented by bi-directional arrow 302, which corresponds to mutual authentication and Diffie Hellman exchange information 234 of FIG. 2. Then M-Card 110 and host media processor 116 generate a CP key as represented by bi-directional arrow 304, which corresponds to CP key generation 236 of FIG. 2. Then host media processor 116 sends encrypted content to M-Card 110 as represented by arrow 306, which corresponds to the sending of encrypted content 248 of FIG. 2.

At this point, M-Card 110 decrypts the content as represented by circle 308. Then M-Card 110 encrypts the content as represented by dot 310, which corresponds to CA decrypt portion 210 deciding whether CA decrypted data 246 needs to be re-encrypted, as discussed above with reference to FIG. 2. In this case, presume that the data is re-encrypted by CP encrypt portion 212.

Now, M-Card 110 sends the encrypted content to host media processor 116 as represented by arrow 312 which corresponds to CP encrypted content 248 of FIG. 2. At this point, host media processor 116 decrypts the content as represented by circle 314, which corresponds to CA decrypt portion 210 receiving CA encrypted content 244 from M-Card 110 of FIG. 2. If the encoded content needs to be converted into another format, then it should be sent to transcoder 123. However, the content must be protected. As such, before the content is sent to transcoder 123, host media processor 116 encrypts the content as represented by dot 316, which corresponds to CP encrypt portion 216 of FIG. 2. Then the encrypted content is then sent to transcoder 123 as represented by arrow 318, which corresponds to private CP encrypted content signal 252 of FIG. 2.

Transcoder 123 decrypts the content as represented by circle 320, which corresponds to private CP decrypt portion 218 of FIG. 2. Transcoder 123 then converts the decrypted content into another format, as represented X322. At this point transcoder 123 should return the transcoded content to host media processor 116. However, the transcoded content must be protected. As such, before the transcoded content is sent to host media processor 116, transcoder 123 encrypts the transcoded content as represented by dot 324, which corresponds to private CP encrypt portion 230 of FIG. 2. Then the encrypted transcoded content is sent to host media processor 116 as represented by arrow 326, which corresponds to private CP encrypted content signal 258 of FIG. 2.

Host media processor 116 then decrypts the transcoded content as represented by circle 328, which corresponds to private CP decrypt portion 232 of FIG. 2. Host media processor 116 then plays the transcoded content, as represented by + signal 320.

A problem with a conventional system as discussed above with reference to FIGS. 1-3 is use of valuable encryption processing power that is unnecessary. As illustrated in FIG. 2, CP encrypted content 248 is sent to host media processor 116. Host media processor 116 receives this data and decrypts it, then re-encrypts it, then sends it to the transcoder where the data is decrypted and transcoded. The steps of decryption via CP decrypt block 214 and re-encryption via private CP encrypt block 216 are unnecessary. Another conventional system avoids unnecessary encryption/decryption. This will be discussed below with reference to FIGS. 4-6.

FIG. 4 illustrates an example conventional STB configuration 400 with an inline transcoder.

As illustrated in FIG. 4, STB configuration 400 includes all the elements of FIG. 1, except host media processor 116 has been replaced by host media processor 402 and transcoder 123 has been replaced by transcoder 404. STB configuration 400 additionally includes a tuner 406. For purposes of brevity, elements (and their respective functions) that are common between STB 100 and STB 400 may not be described again.

Operation of M-card with respect to OOB modulator 106 and OOB demodulator 108 is similar to as described with reference to FIG. 1. Diplex filter 104 now provides output signal 130 to IB tuner 112, IB tuner 114, and IB tuner 406. Operation of IB tuner 406 is similar to IB tuner 112 and IB tuner 114 and has been added here to represent that by placing transcoder 404 on M-card 110 return path freed up a transport resource to allow another tuner to host media processor 402 in this configuration.

In operation, placing the transcoder in between M-card 110 and host media processor 402 solves the issue of encrypting the contents going into the transcoder and decrypting the contents out of the transcoder. M-card 110 is already responsible for encrypting all High Value content that it processes. In the configuration, M-card 110 will continue to encrypt High Value content similar to configurations discussed with reference to FIG. 1 and FIG. 2.

Transcoder 404 will decrypt the content received on signal 140 from M-card 110 prior to transcoding. After the transcoding operation is complete, transcoder 404 will re-encrypt the content using the same encryption keys that it used for decryption, thereby re-protecting the content on the way to host media processor 402 via signal 408. Host media processor 402 will decrypt the content as if it had come directly from M-card 110, using the same decryption resources that it would use in the configuration of FIG. 1.

Control interface 154 is still required in configuration 400 between transcoder 404 and host media processor 402. Some non-limiting examples of this interface include USB, PCIe, serial port or any other suitable interface. Host media processor 402 uses control interface 154 to download any code modules required by transcoder 404 to operate, to establish operating parameters for transcoder 404, and to provide the keys to transcoder 404 to enable the encryption and decryption of the protected content. This is further explained using FIG. 5.

FIG. 5 illustrates a functional diagram for STB configuration 400.

FIG. 5 includes a few elements of FIG. 2, namely, M-Card 110, host certificate 202, card certificate 208, and cable head-end command and control portion 242. Additionally, it includes host media processor 402, transcoder 404, private certificate chain A 224, and private certificate chain A 226. Transcoder 404 further includes a CP decrypt portion 502, a private security/authentication portion 504, a transcoding portion 505, and a CP encrypt portion 506. Host media processor 402 further includes a CP processing portion 508, a CP decrypt portion 510 and a private security/authentication portion 512. For purposes of brevity, elements (and their respective functions) that are common between FIG. 2 and FIG. 5 may not be described again.

In this example, each of CP decrypt portion 502, private security/authentication portion 504, transcoding portion 505 and CP encrypt portion 506 are distinct devices. However, in other embodiments, at least two of CP decrypt portion 502, private security/authentication portion 504, transcoding portion 505 and CP encrypt portion 506 may be combined as a unitary device. Further, in some embodiments at least one of CP decrypt portion 502, private security/authentication portion 504 and CP encrypt portion 506 may be implemented as non-transient, tangible computer-readable media for carrying or having computer-executable instructions or data structures stored thereon.

In this example, each of CP processing portion 508, CP decrypt portion 510 and private security/authentication portion 512 are distinct devices. However, in other embodiments, at least two of CP processing portion 508, CP decrypt portion 510 and private security/authentication portion 512 may be combined as a unitary device. Further, in some embodiments at least one of CP processing portion 508, CP decrypt portion 510 and private security/authentication portion 512 may be implemented as non-transient, tangible computer-readable media for carrying or having computer-executable instructions or data structures stored thereon.

In operation, as illustrated in the figure, transcoder 404 is placed in between M-Card 110 and host media processor 402. Function of transcoder 404 is to convert the media content from one digital video format for example, MPEG2 to another digital video format like MPEG4. In this configuration, binding process still takes place according to OP-SP-CCCP2.0 Specification.

M-Card 110 is operable to function as explained earlier with reference to FIG. 1 and FIG. 2. Host media processor 402 communicates with M-Card 110 for mutual authentication and CP key generation as discussed earlier with reference to FIG. 1 and FIG. 4.

Since transcoder 404 sits in between M-Card 110 and host media processor 402, it needs to perform secondary encryption by first CP decrypting the CP encrypted content received from M-Card 110, transcoding it and then CP encrypting it again before providing it to host media processor 402. Transcoder 404 must therefore contain the security function necessary to decrypt and re-encrypt the content.

In order for the system to function properly, host media processor 402 and transcoder 404 perform a mutual authentication function and a secured function for passing the CP key. Private security/authentication portion 504 and private security/authentication portion 512 perform the mutual authentication via interface signal 264 and a secure CP key exchange via interface signal 266.

Note that private security/authentication portions can be implemented using any of the well-known security method, which provide authentication and secure channel communication. A non-limiting example of such a security system is a public/private key system chained to separate certificates like private certificate chain A 224 and private certificate chain A 226.

Transcoder 404 decrypts the private CP encrypted content using CP decrypt portion 502 to generate decrypted content 503. Transcoding portion 505 transcodes decrypted content 503 from a first format into a second format as transcoded content 507. CP encrypt portion 506 then encrypts transcoded content 507 as CP encrypted-transcoded content 514. CP encrypt portion 506 then sends CP encrypted-transcoded content 514 back to host media processor 402. CP decrypt portion 510 receives encrypted-transcoded content 514 and decrypts it. Since transcoder 404 is placed in between M-Card 110 and host media processor 402, the extra steps of private CP encrypting and decrypting the content as shown by private CP encrypt portion 216 and private CP decrypt portion 218 are not required in the configuration.

Since host media processor 402 cannot receive high value content until it has completed binding with M-Card 110 using OP-SP-CCCP2.0 specifications, the secondary encryption between transcoder 404 and host media processor 402 is dependent on OP-SP-CCCP2.0 process. Without binding, or in the event that a particular host certificate has been revoked, no High Value content will be transmitted, and host media processor 402 has no CP key to share with transcoder 404. In the event when private certificates are used between transcoder 404 and host media processor 402, the chain can also be validated and revoked via private and remote means, which can also be used to enable and disable the Private CP process between transcoder 404 and host media processor 402.

As discussed above with reference to FIG. 4 and FIG. 5, transcoder 404 is placed in between M-Card 110 and host media processor 402. The binding process between M-Card 110 and host media processor 402 still takes place using OP-SP-CCCP2.0 specifications. Since transcoder 404 is placed in between M-Card 110 and host media processor 402, it first CP decrypts the media content, transcodes it and then CP re-crypts it before passing it to host media processor 402. Transcoder 404 is required to contain necessary security functions in order to be able to decrypt and encrypt the content.

FIG. 6 is a timing diagram, illustrating the relative time of process of M-Card 110, host media processor 402, and transcoder 504 of STB configuration 400 of FIG. 5.

In operation, as illustrated in FIG. 6, M-Card 110 and host media processor 402 are mutually authenticated as represented by bi-directional arrow 302, which corresponds to mutual authentication and Diffie Hellman exchange information 234 of FIG. 5. Then M-Card 110 and host media processor 402 generate a CP key as represented by bi-directional arrow 304, which corresponds to CP key generation 236 of FIG. 5. Then host media processor 402 sends encrypted content to M-Card 110 as represented by arrow 306, which corresponds to the send of encrypted content 244 of FIG. 5.

At this point, M-Card 110 decrypts the content as represented by circle 308, which corresponds to CA decrypt portion 210 receiving CA encrypted content 244 from host media processor 116, which has been encrypted by any known method as discussed above with reference to FIG. 5. Then M-Card 110 encrypts the content as represented by dot 310, which corresponds to CA decrypt portion 210 deciding whether CA decrypted data 246 needs to be re-encrypted, as discussed above with reference to FIG. 5. In this case, presume that the data is re-encrypted by CP encrypt portion 212.

Now, M-Card 110 sends the encrypted content to transcoder 404 as represented by arrow 602, which corresponds to CP encrypted content 248 of FIG. 5. At this point, transcoder 404 decrypts the content as represented by circle 604, which corresponds to CP decrypt portion 502 of FIG. 5.

Transcoder 404 then converts the decrypted content into another format, as represented by X606. At this point transcoder 404 should send the transcoded content to host media processor 402. However, the transcoded content must be protected. As such, before the transcoded content is sent to host media processor 402, transcoder 404 encrypts the transcoded content as represented by dot 610, which corresponds to CP encrypt portion 506 of FIG. 5. Then the encrypted transcoded content is then sent to host media processor 402 as represented by arrow 612, which corresponds to signal 514 of FIG. 5.

Host media processor 402 then decrypts the transcoded content as represented by circle 614, which corresponds to CP decrypt portion 510 of FIG. 5. Host media processor 402 then plays the transcoded content, as represented by + sign 616.

As discussed with reference to FIGS. 1-6 represent a separable security system including a CableCard and a Host. The CableCard and the Host exchange information back and forth and ultimately the content is passed to the CA device, which decrypts it and removes any conditional access encryption. It reapplies a copy protection encryption method to protect the content before providing it back to the Host. Host can CP decrypt the content, decode it, store it or send it out as needed.

A problem with a conventional system as discussed above with reference to FIGS. 4-6 deals with the difficulty in implementing the M-Card/Transcoder interface correctly. In particular, it requires that the transcoder implement the M-Card interface, which includes both hardware and software components. Further, the transcoder then has to be integrated/tested/qualified etc. Accordingly, not all conventional transcoders have an M-card interface. For those that have an M-card interface, they must also implement the software interfaces to make it useable. As such, implementing conventional transcoders in this manner requires rigorous scheduling, work, etc., and it limits the pool of transcoders that might be selected, e.g., they must have an M-card interface.

What is needed is a system and method for transcoding the media content efficiently while also being able to implement the Cable Card interface with the rest of the system hardware, while still being able to transcode data efficiently.

### BRIEF SUMMARY OF THE DRAWINGS

The accompanying drawings, which are incorporated in and form a part of the specification, illustrate non-limiting example embodiments and, together with the description, serve to explain the principles of the non-limiting example embodiments. In the drawings:

FIG. 1 illustrates a block diagram for a prior art STB configuration;

FIG. 2 illustrates a functional diagram for the prior art STB of FIG. 1;

FIG. 3 illustrates a timing diagram for the prior art STB of FIG. 1;

FIG. 4 illustrates a block diagram for a prior art STB configuration;

FIG. 5 illustrates a functional diagram for the prior art STB of FIG. 3;

FIG. 6 illustrates a timing diagram for the prior art STB of FIG. 3;

FIG. 7 illustrates a STB configuration, in accordance with aspects of the non-limiting example embodiments;

FIG. 8 illustrates a functional diagram for the STB configuration of FIG. 7, in accordance with aspects of non-limiting example embodiments;

FIG. 9 illustrates a timing diagram for the STB of FIG. 7, in accordance with aspects of non-limiting example embodiments;

FIG. 10 illustrates another timing diagram for the STB of FIG. 7, in accordance with aspects of non-limiting example embodiments: and

FIG. 11 illustrates a functional diagram for a STB configuration that does not include a conditional access device, in accordance with aspects of non-limiting example embodiments.

### DETAILED DESCRIPTION

Aspects of non-limiting example embodiments provide a system and method for securely transferring media content from a conditional access device to a transcoder, transcoding the media content from one format to another format with the transcoder, and then securely transferring the transcoded media content to a host media processor. The media content is “securely transferred” when it is inaccessible to all but the intended receiver. Accordingly, when the media content is securely transferred from the conditional access device to the transcoder, the data will be inaccessible to anyone but the transcoder. Similarly, when the transcoded media content is securely transferred from the transcoder to the host media processor, the data will be inaccessible to anyone but the host media processor.

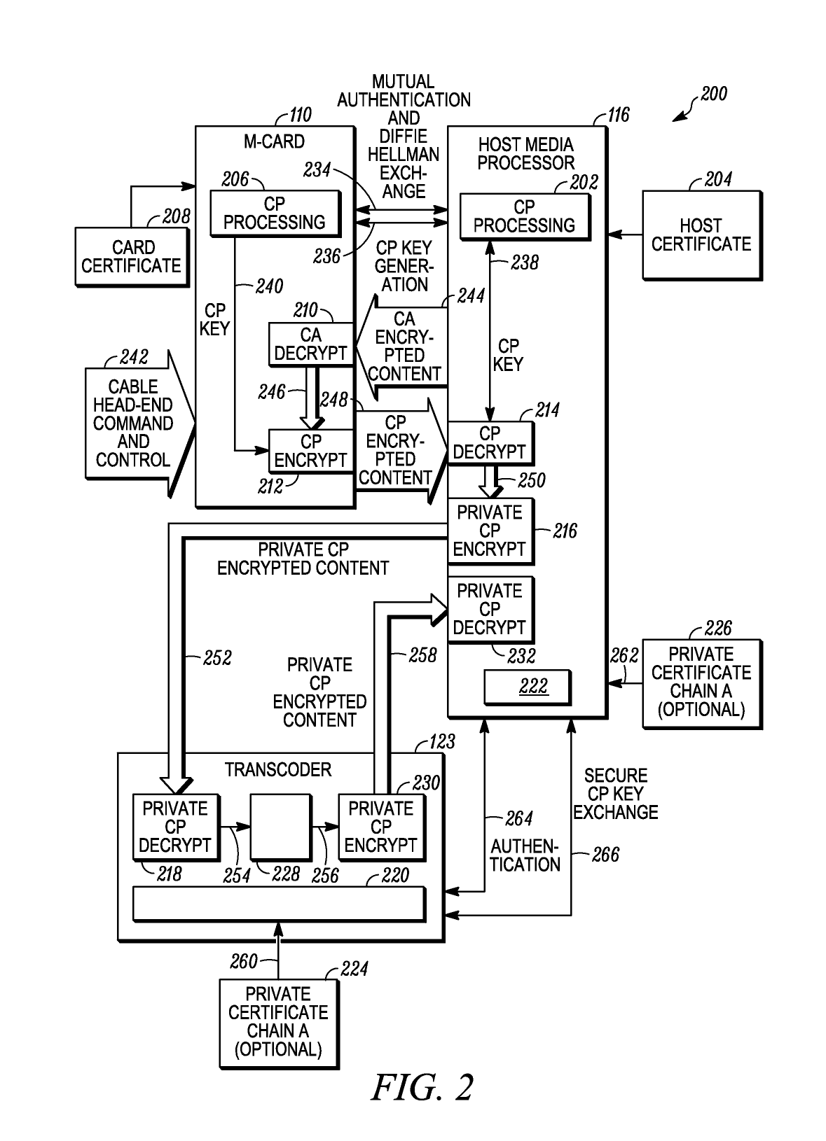

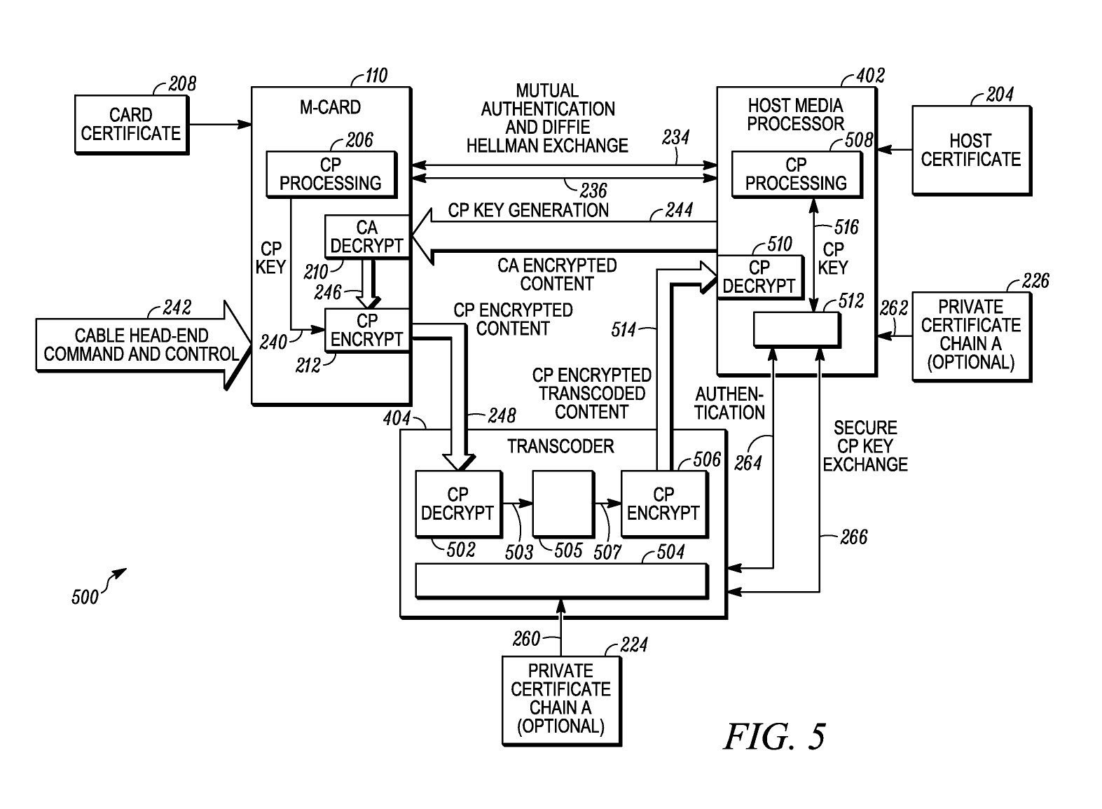

Non-limiting example embodiments described herein provide a system and method for transcoding the media content over an existing interface between the M-Card and the host media processor. By arranging M-Card, host media processor, and the transcoder such that encrypted data must pass from the M-Card, through the host media processor and then to the transcoder, the additional steps of private CP decrypting and private CP encrypting or CP decrypting and CP encrypting, utilized in the prior art methods illustrated in FIG. 2 and FIG. 5 are not needed.

In accordance with non-limiting example embodiments, a system is provided for use with secure content in a first format. The system includes a conditional access device, a transcoding device and a media processor. The conditional access device is operable to receive the secure content and can generate a second secure content based on the secure content. The conditional access device can further provide the second secure content to the transcoding device. The transcoding device can transcode the second secure content into transcoded content of a second format, can secure the transcoded content as secure transcoded content and can provide the secure transcoded content to the media processor.

In accordance with other non-limiting example embodiments, another system is provided for use with secure content in a first format. The system includes a transcoding device and a media processor. The media processor is operable to receive the secure content and a key for decrypting the content. The media processor can further provide the secure content and the key to the transcoding device. The transcoding device can transcode the second secure content into transcoded content of a second format, can secure the transcoded content as secure transcoded content and can provide the secure transcoded content back to the media processor.

Additional advantages and novel features of non-limiting example embodiments are set forth in part in the description which follows, and in part will become apparent to those skilled in the art upon examination of the following or may be learned by practice of non-limiting example embodiments. The advantages of non-limiting example embodiments may be realized and attained by means of the instrumentalities and combinations particularly pointed out in the appended claims.

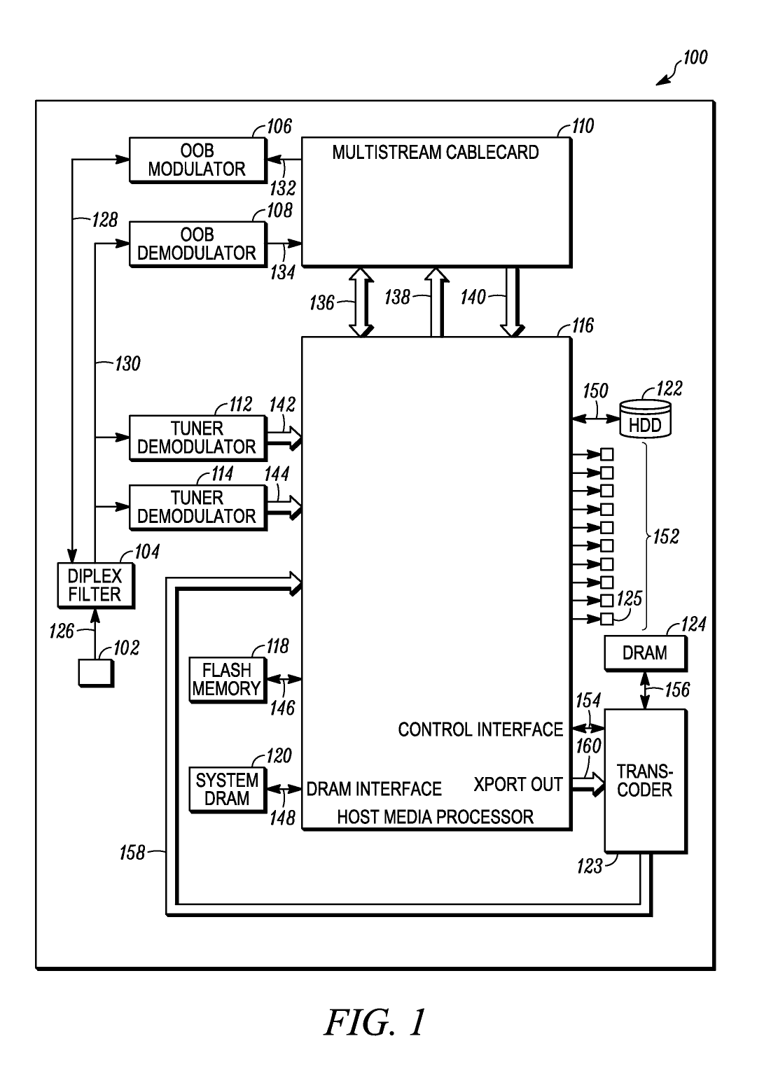

In contrast with the conventional system discussed above with reference to FIGS. 1-3, in accordance with non-limiting example embodiments, CP decrypt portion 214 and private CP encrypt portion 216 have been eliminated. In the place of CP decrypt portion 214 and private CP encrypt portion 216 there is a data forwarding portion. This data forward portion simply forwards CP encrypted data 248 and CP key 238 to the transcoder.

The transcoder receives the encrypted data as well as the CP key and performs the decryption process itself, transcodes the data, re-encrypts it, and sends the newly encrypted and transcoded data back to the host media processor. This process improves on prior art STB 100 by eliminating one decryption process and one encryption process, which saves valuable processor power.

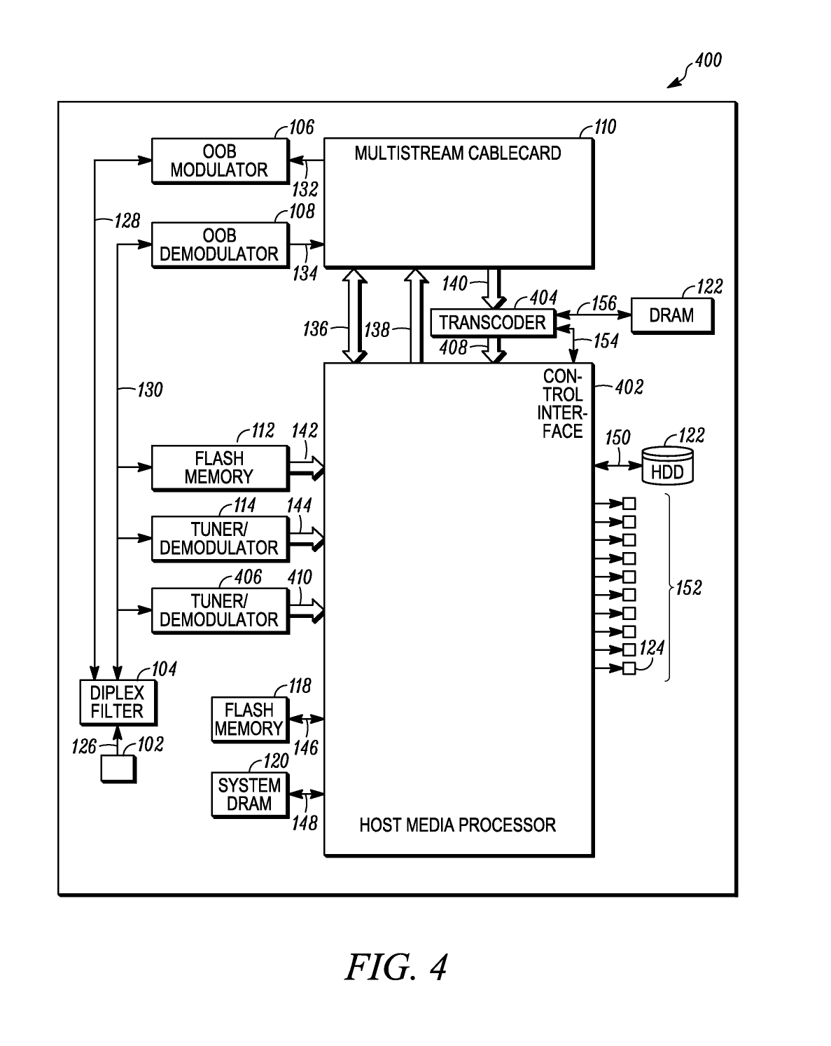

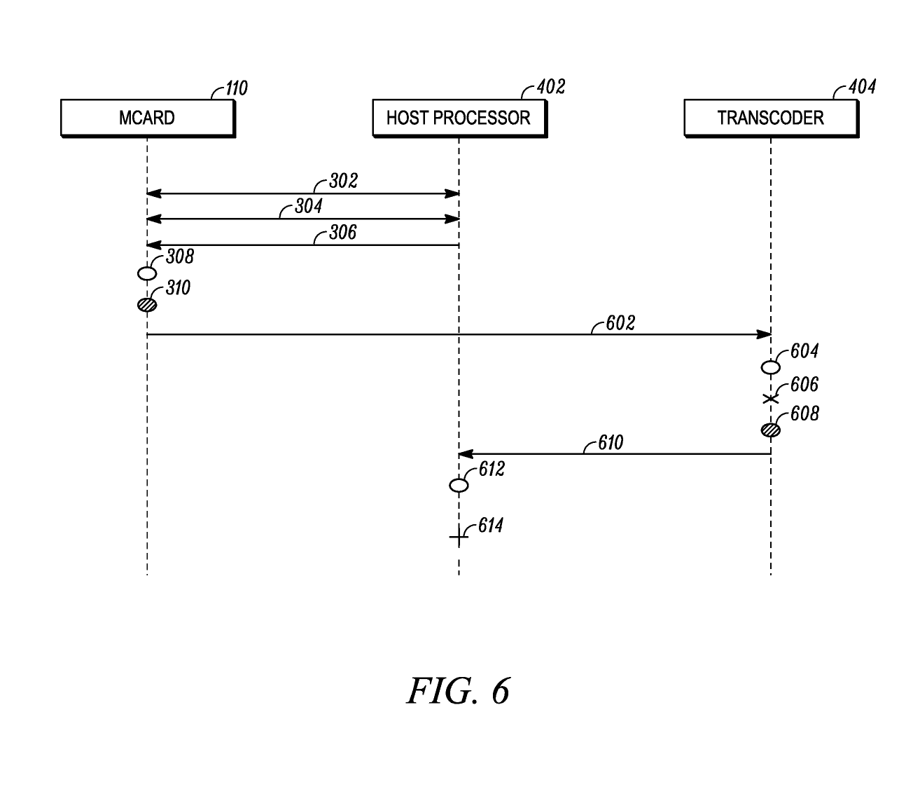

In contrast with the conventional system discussed above with reference to FIGS. 4-6, in accordance with non-limiting example embodiments, the transcoder is no longer disposed between the Cable Card and the host media processor. The advantage with a system in accordance with non-limiting example embodiments is that the existing Host Media Process interface to the M-Card (hardware and software) is continuously leveraged. Further, a system in accordance with non-limiting example embodiments does not require the M-card hardware and software on the transcoder. This saves time and development, and increases transcoder choices. What may be added is a relatively light protocol (when compared with an M-card interface) to pass the key securely from host media processor to the transcoder, and forward the encrypted content on a standard interface that the transcoder must support by default.

In accordance with aspects of non-limiting example embodiments, the M-Card sends data to the host media processor, which forwards the data to the transcoder, and the transcoded content is sent back to the host media processor. In this arrangement, decryption and re-encryption steps are removed from the host processor. Content decryption keys obtained from the conditional access device are passed through by the host processor to the transcoder. Content re-encryption keys may be the same decryption keys or may be separately generated by the host processor and are also forwarded to the transcoder. The transcoder then performs content decryption followed by transcoding and then re-encryption.

In a non-limiting example embodiment described herein, the conditional access device is an M-Card.

In a non-limiting example embodiment, a transcoder securely receives media content from a conditional access device by way of an encryption system, wherein the conditional access device encrypts the media content, and the transcoder decrypts the media content. In other non-limiting example embodiments, any secure communication system, method or protocol may be used. For purposes of explanation, an example embodiment described herein includes an encryption system for securely transferring media content from the conditional access device to the transcoder.

In a non-limiting example embodiment, a host media processor securely receives transcoded media content from a transcoder by way of an encryption system, wherein the transcoder encrypts the media content, and the host media processor decrypts the transcoded media content. In other non-limiting example embodiments, any secure communication system, method or protocol may be used. For purposes of explanation, an example embodiment described herein includes an encryption system for securely transferring transcoded media content from the transcoder to the host media processor.

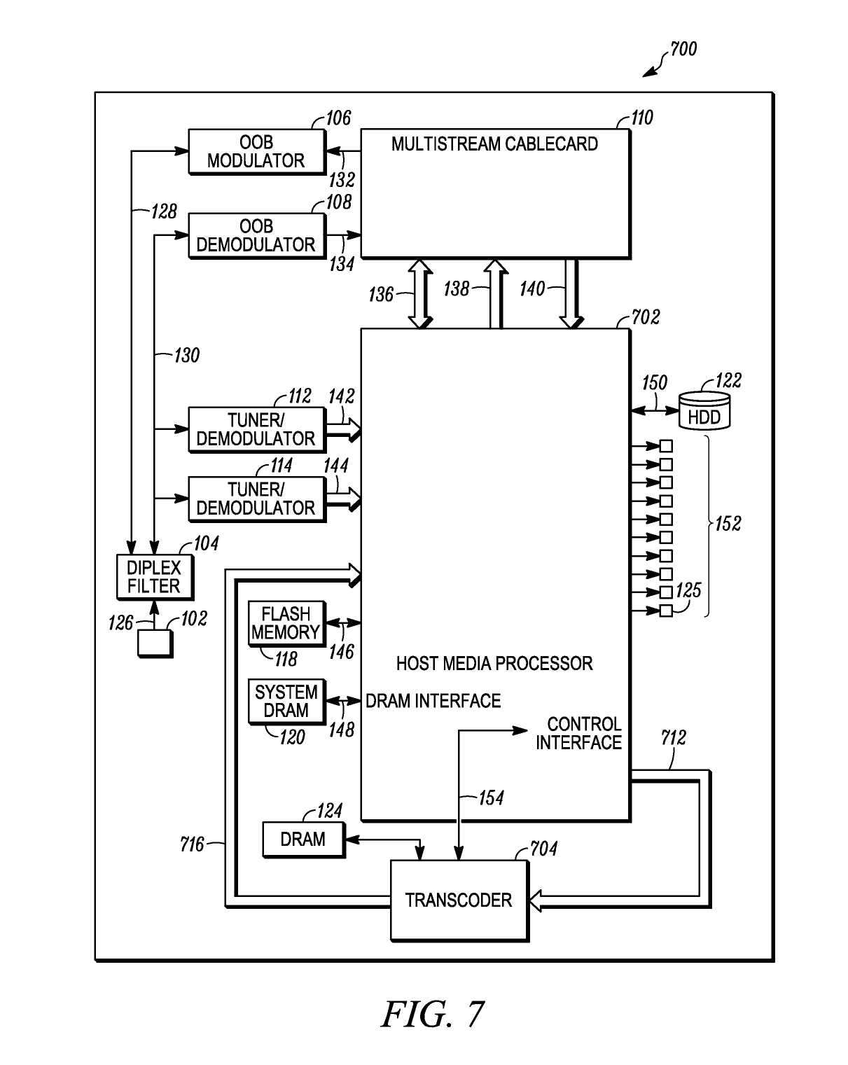

By arranging M-Card, the host media processor and the transcoder such that the same encrypted data with the original encryption must pass from the M-Card, through the host media processor and then to the transcoder, minimizes the additional steps of private encrypting/decrypting and CP encrypting/decrypting and therefore requires much lower use of the encryption and decryption processing resources. This will be further explained below using FIGS. 7-9.

An example STB with a transcoder in accordance with aspects of non-limiting example embodiments, will now be discussed further using FIGS. 7-9.

FIG. 7 illustrates an STB configuration 700 with a transcoder, in accordance with aspects of non-limiting example embodiments.

As illustrated in the figure, STB 700 includes all of the elements of FIG. 1, except host media processor 116 has been replaced with host media processor 702 and transcoder 123 has been replaced by transcoder 704. For purposes of brevity, elements (and their respective functions) that are common between STB 100 and STB 700 may not be described again.

Similar to host media processor 116 discussed above with reference to FIG. 1, host media processor 702 receives media content from M-Card 110, which may or may not be encrypted depending on the IP rights. For purposes of discussion assume, in this example embodiment, that the content is encrypted.

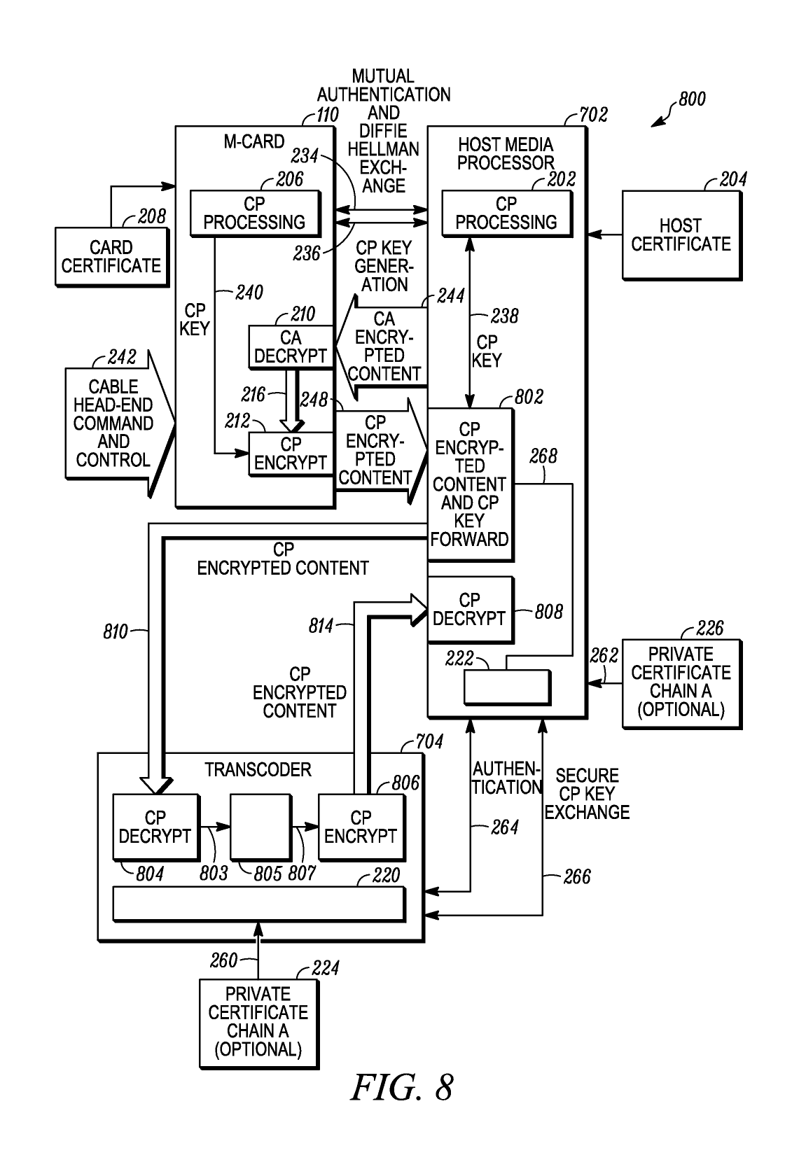

Host media processor 702 forwards the encrypted content it receives without decrypting and re-encrypting the data. The encrypted content and key are sent to transcoder 704 where the content is decrypted, transcoded, re-encrypted, and sent to host media processor 702. Host media processor 702 can store this newly encrypted content on HDD 122 or send it out to peripheral device 125. This is further explained using FIG. 8.

FIG. 8 is a functional diagram of STB configuration 700, in accordance with aspects of the non-limiting example embodiments.

FIG. 8 includes some common elements of FIG. 2, namely M-Card 110, host certificate 204, card certificate 208, and cable head-end command 242, private certificate chain A 224, and private certificate chain A 226. Additionally, it includes host media processor 702 and transcoder 704. Host media processor 702 further includes CP processing portion 202, a CP encrypted content and CP key forward (FWD) portion 802, a CP decrypt portion 808 and security/authentication portion 222. Transcoder 704 further includes a CP decrypt portion 804, security/authentication portion 220 and a CP encrypt portion 806. For purposes of brevity, elements (and their respective functions) that are common between FIG. 2 and FIG. 8 may not be described again.

CP processing portion 202, FWD portion 802, security/authentication portion 222, and CP decrypt portion 808 are functional elements that may be contained in a single device or separate devices. Those of skill in the art would appreciate that the functions performed by a single device may provide increased security. Further, in some non-limiting example embodiments, at least one of CP processing portion 202, FWD portion 802, security/authentication portion 222, and CP decrypt portion 808 may be implemented as a non-transient, tangible computer-readable media for carrying or having computer-executable instructions or data structures stored thereon.

CP decrypt portion 804, CP encrypt portion 806, and security/authentication portion 220 are functional elements that may be contained in a single device or separate devices. Those of skill in the art would appreciate that the functions performed by a single device may provide increased security. Further, in some non-limiting example embodiments, at least one of CP decrypt portion 804, CP encrypt portion 806, and security/authentication portion 220 may be implemented as a non-transient, tangible computer-readable media for carrying or having computer-executable instructions or data structures stored thereon.

Initial functional behavior of STB 800 is similar to that of STB 200 with respect to mutual authentication, loading the CP key, decrypting the CA encrypted content received from host media processor 702 by CA decrypt portion 210 and encrypting it again by CP encrypt portion 212.

At this point, CP processing portion 202 sends CP key 238 to FWD portion 802. When CP encrypt portion 212 sends CP encrypted content 248 it is also received by FWD portion 802. Instead of decrypting the data, FWD portion 802 forwards CP encrypted content 810 to transcoder 704. Transcoder 704 obtains a key to decrypt CP encrypted content 810.

Once transcoder obtains CP key 238, transcoder 704 decrypts CP encrypted data 810 using CP key 238 and CP decrypt portion 804 to generate decrypted content 803. Transcoding portion 805 transcodes decrypted content 803 from a first format into a second format as transcoded content 807.

CP encrypt portion 806 then uses a re-encryption key to encrypt transcoded content 807 into CP encrypted content 814.

In some non-limiting example embodiments, CP key 238 doubles as the re-encryption key, wherein FWD portion 802 forwards CP key 238 to secure CP key exchange 266 via signal 268. CP key 238 is sent to transcoder 704 by secure CP key exchange 266 so it may be used to decrypt forwarded CP encrypted content 810.

In some non-limiting example embodiments, transcoder 704 obtains the second key, or the re-encryption key, by receiving the second key from host media processor 702. For example, FWD portion 802 may forward CP key 238 and a separate second key to secure CP key exchange 266 via signal 268. The separate second key may be sent to transcoder 704 by secure CP key exchange 266 so it may be used to encrypt transcoded content 807.

In some non-limiting example embodiments, transcoder 704 obtains the second key by generating the second key itself In an example embodiment, FWD portion 802 forwards instructions to transcoder 704 via secure CP key exchange 266, wherein transcoder 704 is able to generate the second key based on the instructions. In another embodiment, transcoder 704 may generate a second key based on IP rights associated with the content. In a non-limiting example, some portion of the IP rights may be used as a key seed to generate the second key.

There may be situations where transcoder 704 may generate the second key based on IP rights associated with the content and where the IP rights associated with the content change. The IP rights may change for many reasons, non-limiting examples of which include changing based on time or changing based on the transcoded format. For example, and only for purposes of discussion, presume that transcoder 704 is able to transcode MPEG 4 content into MPEG 2 content. Further, and only for purposes of discussion, presume that the IP rights associated with the content in the MPEG 4 format are different than the IP rights associated with the content in the MPEG 2 format. In this situation, when transcoder 704 generates the second key based on IP rights associated with the content, the new IP rights are embedded into the transcoded content. Eventually, when host media processor 702 decrypts the encrypted MPEG 2 formatted content, the decrypted content will have the new IP rights associated with the MPEG 2 formatted content.

Once the decrypted content has been transcoded and re-encrypted, CP encrypt portion 806 then sends CP encrypted content 814 back to host media processor 702. CP encrypt portion 808 receives and decrypts CP encrypted content 814.

Note that private security/authentication portions can be implemented using any well-known security method, which provide authentication and secure channel communication. A non-limiting example of which includes a public/private key system chained to separate certificates like private certificate chain A 224 and private certificate chain A 226.

A non-limiting example of authenticating between a host media processor and a transcoder involves the secure ‘preloading’ of secret keys into the transcoder and the host media processor at the time of manufacture. With this type of authentication arrangement, the transcoder and the host media processor would thus be paired and may then securely communicate without the need to exchange certifications/keys. Accordingly, with this type of authentication arrangement, there would be no need for a secure CP exchange between transcoder 704 and host media processor 702, for example by way of CPU interface signal 266.

In the event when private certificates are used between transcoder 704 and host media processor 702, the chain can also be validated and revoked via private and remote means, which can also be used to enable and disable the Private CP process between transcoder 704 and host media processor 702.

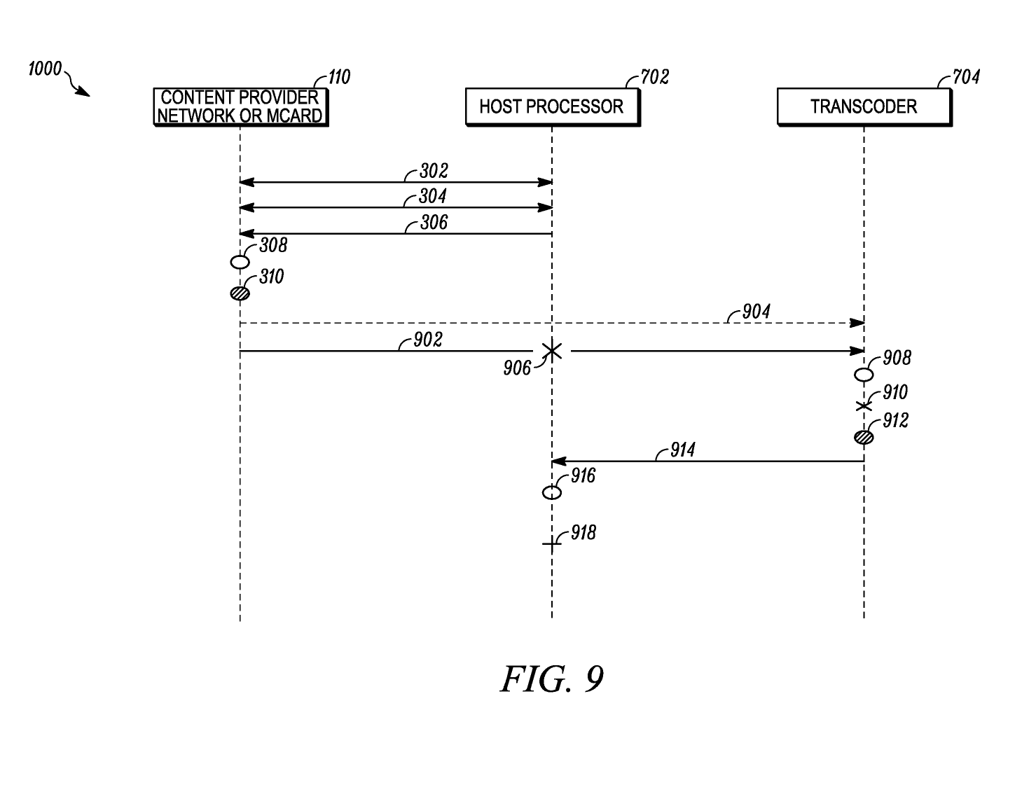

FIG. 9 is a timing diagram, illustrating the relative time of process of M-Card 110, host media processor 702, and transcoder 704 of STB configuration 700 of FIG. 8, with aspects of non-limiting example embodiments. It should be noted that in some non-limiting example embodiments, the encrypted content and keys may be provided by a content provider over a network, as opposed to an M-Card. Accordingly, for purposes of discussion, in this example the processes of M-Card 110 may be from a Content Provider Network or M-Card 110.

In operation, as illustrated in FIG. 8, M-Card 110 and host media processor 702 are mutually authenticated as represented by bi-directional arrow 302, which corresponds to mutual authentication and Diffie Hellman exchange information 234 of FIG. 8. The Diffie-Hellman key exchange can be replaced by any other secure key agreement algorithm such as for example ECDH—Elliptical Curve Diffie-Hellman. Then M-Card 110 and host media processor 702 generate a CP key as represented by bi-directional arrow 304, which corresponds to CP key generation 236 of FIG. 8. Then host media processor 702 sends encrypted content to M-Card 110 as represented by arrow 306, which corresponds to the send of encrypted content 244 of FIG. 8.

At this point, M-Card 110 decrypts the content as represented by circle 308, which corresponds to CA decrypt portion 210 receiving CA encrypted content 244 from host media processor 702, which has been encrypted by any known method as discussed above with reference to FIG. 8. Then M-Card 110 encrypts the content as represented by dot 310, which corresponds to CA decrypt portion 210 deciding whether CA decrypted data 246 needs to be re-encrypted, as discussed above with reference to FIG. 8. In this case, presume that the data is re-encrypted by CP encrypt portion 212.

Now, M-Card 110 sends the encrypted content to host media processor 702 as represented by line 902, which corresponds to CP encrypted content 248 of FIG. 8. At this point, host media processor 702 forwards the encrypted content to transcoder 704 as represented by * 906, which corresponds to FWD portion 802.

Secure CP key exchange 266 sends CP key 238 to transcoder 704 as represented by dashed line 904. In this example, CP key 238 is sent to transcoder 704 before M-Card 110 sends the encrypted content to host media processor 702. However, in other non-limiting example embodiments, CP key 238 is sent to transcoder 704 after M-Card 110 sends the encrypted content to host media processor 702. Further, in some non-limiting example embodiments, CP key 238 is sent to transcoder 704 while M-Card 110 sends the encrypted content to host media processor 702.

In one example embodiment, a single key is sent to transcoder 704, which is used to decrypt forwarded CP encrypted content 810 and to re-encrypt transcoded data 807.

In another example embodiment, two keys may be sent to transcoder 704. For example, a first key may be used by CP decrypt portion 804 to decrypt CP encrypted content 810, whereas a second key may be used by CP encrypt portion 806 to re-encrypt transcoded content 807.

In yet another example embodiment, a newly generated key may be sent to transcoder 704 at any time to be used by CP decrypt 804 and CP encrypt 806. This newly generated key may be created by Diffie-Hellman exchange 234 between M-Card 110 and host media processor 702. Once it is newly generated between M-Card 110 and host media processor 702, host media processor 702 will forward the newly generated key to transcoder 704.

A new key may need to be generated for several reasons, as known to those of skill in the art. One non-limiting example reason for generating a new key is drawn to the situation where the IP rights of the content changes. Another non-limiting example reason for generating a new key is drawn to the situation where M-Card 110 detects that the currently used key has, or is about to, expire.

At this point, transcoder 704 decrypts the content as represented by circle 908, which corresponds to CP decrypt portion 804 of FIG. 8. Transcoder 704 then converts the decrypted content into another format, as represented by X 910.

Transcoder 704 should send the transcoded content to host media processor 702. However, the transcoded content must be protected. As such, before the transcoded content is sent to host media processor 702, transcoder 704 encrypts the transcoded content as represented by dot 912, which corresponds to CP encrypt portion 806 of FIG. 8. Then the encrypted transcoded content is then sent to host media processor 702 as represented by arrow 914, which corresponds to CP encrypted content signal 814 of FIG. 8.

Host media processor 702 then decrypts the transcoded content as represented by circle 916, which corresponds to CP decrypt portion 808 of FIG. 8. Host media processor 702 then plays the transcoded content, as represented by + sign 918.

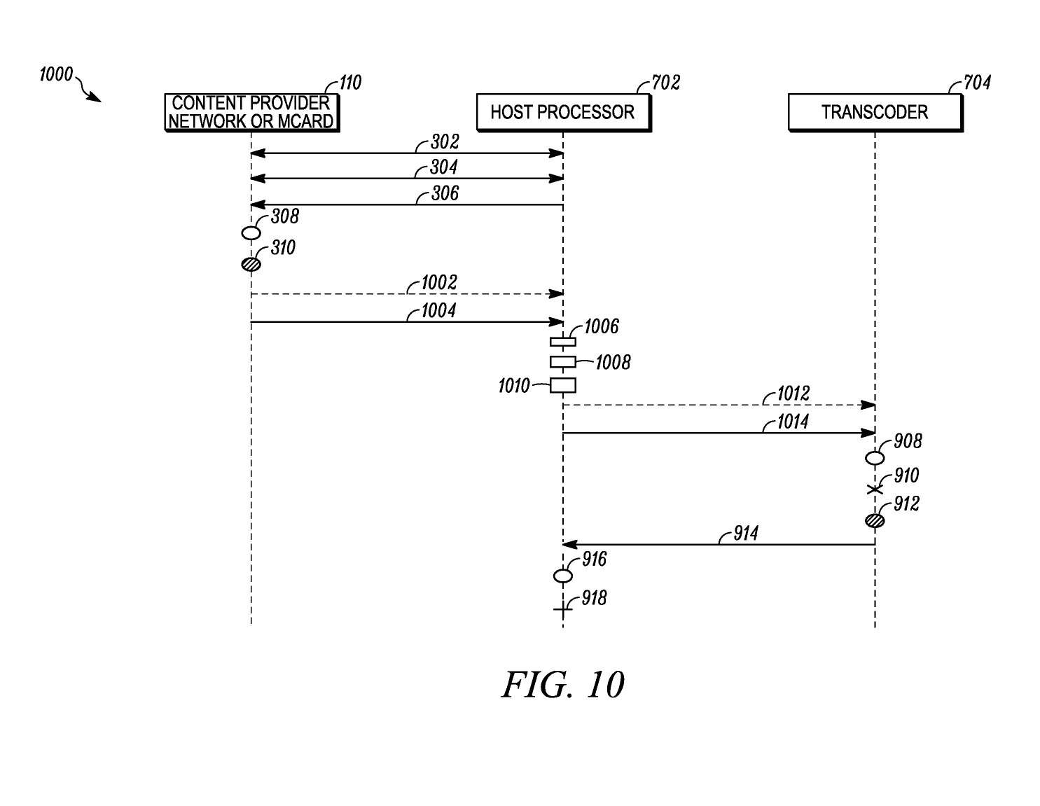

In yet another example embodiment, if transcoded content with the original encryption and the corresponding CP key(s) along with content usage rights and restrictions are saved on a DVR to be played at a later time, host media processor 702 does not have to pass the content and CP key(s) for transcoding and decryption to the transcoder until the time when the user decides to play back the content to have CP decrypt portion 808 decrypt the content. Instead, the DVR may save the encrypted content as well as the CP key received from secure CP key exchange 266 in secure/protected storage on the device. In a further embodiment, if more than one CP key is used for the encryption and decryption of the transcoded content, the DVR may save multiple CP keys or a base key and the associated information for deriving multiple keys. The case of content being provided by a Content Provider Network (no M-Card) or the storage of content to be played at a later time will now be further discussed with reference to FIG. 10.

FIG. 10 is a timing diagram, illustrating the relative time of process of M-Card 110, host media processor 702, and transcoder 704 of STB configuration 700 of FIG. 8, with respects to playback of stored media, in accordance with aspects of non-limiting example embodiments.

The initial operation of FIG. 10 is similar to that of FIG. 9, with respects to mutual authentication between Content Provider Network or M-Card 110 and host media processor 702, CP key generation, host media processor 702 sending encrypted content to Content Provider Network or M-Card 110, the Content Provider Network or M-Card 110 decrypting the content and then sending the content and CP key to host media processor 702. The content being sent to host media processor 702 is represented by dashed line 1002 and the CP key being sent to host media processor 702 is represented by line 1004.

At this point, host media processor 702 creates a new CP key and uses the newly generated key to encrypt the content. After the content is encrypted, host media processor 702 sends the newly encrypted content as well as the CP key (in an encrypted form) to a local persistent storage (e.g. hard disk), as represented by square 1006. At a later time, a user will request content playback, which is represented by square 1008.

Once a user has requested content playback host media processor 702 retrieves the CP key from persistent storage and decrypts it as shown by square 1010. Once the CP key is decrypted, it is forwarded to transcoder 704 as represented by dashed line 1012. Host media processor 702 also retrieves the encrypted content that requested for playback and forwards it to transcoder 704, as represented by solid line 1014.

At this point, transcoder 704 decrypts the content as represented by circle 908, which corresponds to CP decrypt portion 804 of FIG. 8. Transcoder 704 then converts the decrypted content into another format, as represented by X 910.

Transcoder 704 should send the transcoded content to host media processor 702. However, the transcoded content must be protected. As such, before the transcoded content is sent to host media processor 702, transcoder 704 encrypts the transcoded content as represented by dot 912, which corresponds to CP encrypt portion 806 of FIG. 8. Then the encrypted transcoded content is then sent to host media processor 702 as represented by arrow 914, which corresponds to CP encrypted content signal 814 of FIG. 8.

Host media processor 702 then decrypts the transcoded content as represented by circle 916, which corresponds to CP decrypt portion 808 of FIG. 8. Host media processor 702 then plays the transcoded content, as represented by + sign 918.

In a non-limiting example, host media processor 702 may not play the transcoded content. Instead, host media processor 702 may simply forward the encrypted content to another device via an external interface. A non-limiting example of an external interface may be a DLNA interface protected with DTCP-IP, an IEEE-1394 interface protected with DTCP, or an Xbox interface protected using PlayReady-ND DRM.

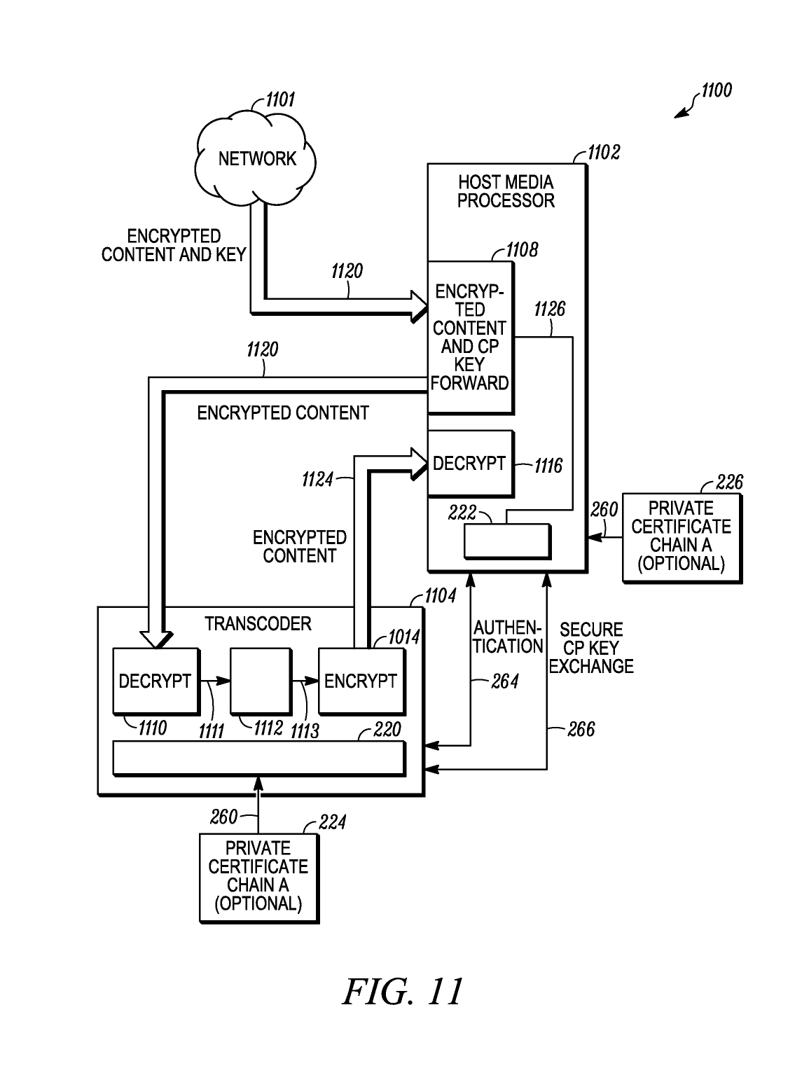

FIG. 11 represents a functional diagram of a STB configuration that receives content from a provider other than an M-Card.

FIG. 11 includes some common elements of FIG. 8, namely private certificate chain A 224, private certificate chain A 226. Additionally, it includes host media processor 1102 and transcoder 1104. Host media processor 1102 further includes, an encrypted content and key forward (FWD) portion 1108, a decrypt portion 1116 and security/authentication portion 222. Transcoder 1104 further includes a decrypt portion 1110, transcoding portion 1112, encrypt portion 1114 and a security/authentication portion 220. For purposes of brevity, elements (and their respective functions) that are common between FIG. 2 and FIG. 8 may not be described again.

FWD portion 1108, security/authentication portion 222, and decrypt portion 1116 are functional elements that may be contained in a single device or separate devices. Those of skill in the art would appreciate that the functions performed by a single device may provide increased security. Further, in some non-limiting example embodiments at least one of FWD portion 1108, security/authentication portion 222, and decrypt portion 1116 may be implemented as a non-transient, tangible computer-readable media for carrying or having computer-executable instructions or data structures stored thereon.

Decrypt portion 1110, transcoding portion 1112, encrypt portion 1114, and security/authentication portion 220 are functional elements that may be contained in a single device or separate devices. Those of skill in the art would appreciate that the functions performed by a single device may provide increased security. Further, in some non-limiting example embodiments at least one of decrypt portion 1110, transcoding portion 1112, encrypt portion 1114, and security/authentication portion 220 may be implemented as a non-transient, tangible computer-readable media for carrying or having computer-executable instructions or data structures stored thereon.

In operation, FWD portion 1108 of host media processor 1102 receives encrypted content and a DRM protected content decryption key from a content provider. In a non-limiting example embodiment, a content provider may be the internet, or a content provider within the network. Once the encrypted content and content decryption key have been received, FWD portion 1108 forwards the content to transcoder 1104 and the content decryption key to secure key exchange 266 via signal 1126.

Private security/authentication portion 220 receives a private certificate chain A 224 via signal 260. Similarly, private security/authentication portion 222 receives a private certificate from private certificate chain A 226 via signal 262. Private security/authentication portion 220 and private security/authentication portion 222 communicate with each other via CPU interface signals 264 and 266 in order to establish mutual authentication and content decryption key exchange.

Once transcoder 1104 has received the encrypted content from FWD portion 1108 and the content decryption key from secure key exchange 266, transcoder 1104 decrypts encrypted data 1122 using the forwarded content decryption key and decrypt portion 1010 to generate decrypted content 1111. Transcoding portion 1112 transcodes decrypted content 1111 from a first format into a second format as transcoded content 1113. Encrypt portion 1114 then uses a second key to encrypt transcoded content 1113 into encrypted content 1124.

The second key used to encrypt transcoded content 1113 may be obtained or derived in a variety of methods as discussed above with reference to FIG. 8.

Once the decrypted content has been transcoded and re-encrypted, encrypt portion 1114 then sends encrypted content 1124 back to host media processor 1102. Decrypt portion 1116 receives and decrypts encrypted content 1124.

Note that private security/authentication portions can be implemented using any well-known security method, which provide authentication and secure channel communication. A non-limiting example of which includes a public/private key system chained to separate certificates like private certificate chain A 224 and private certificate chain A 226.

In the event when private certificates are used between transcoder 704 and host media processor 702, the chain can also be validated and revoked via private and remote means, which can also be used to enable and disable the Private CP process between transcoder 704 and host media processor 702.

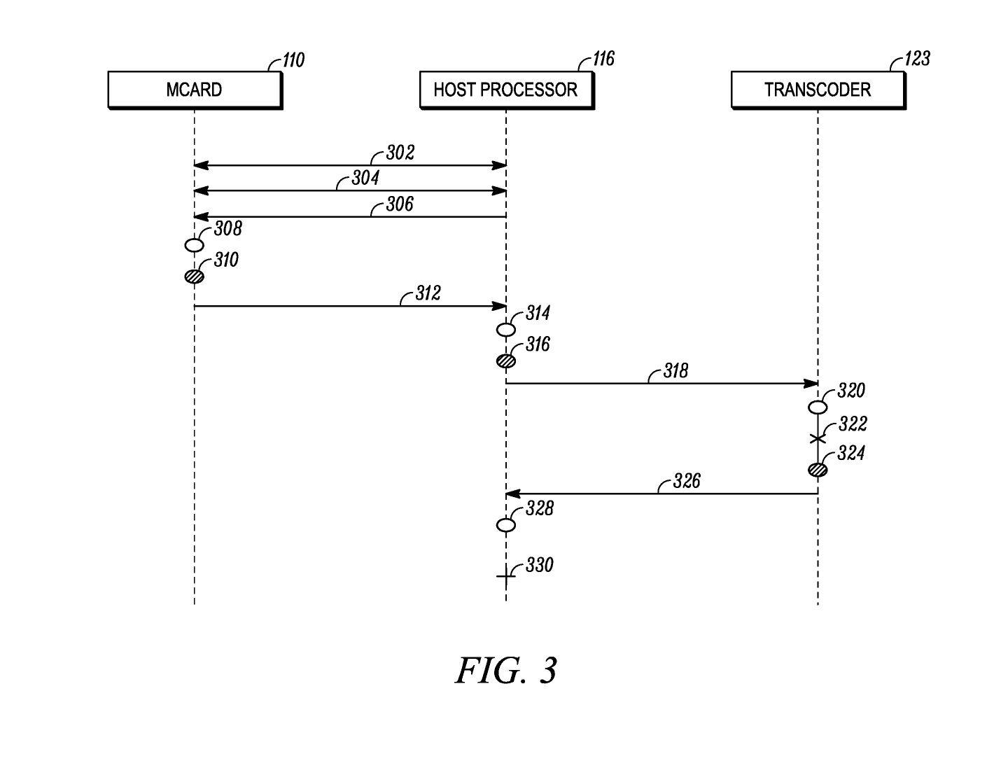

It is easy to see the benefit of non-limiting example embodiments when comparing FIG. 9 to FIG. 3. As seen in FIG. 9 with STB 700, there are only three decryption processes and two encryption processes. However, in the conventional system discussed above with reference to FIG. 3 there are four decryption processes and three encryption processes. STB 700, in accordance with aspects of non-limiting example embodiments, reduces the number of encryptions and decryptions needed by one. This saves on the consumption of valuable computing resources that are needed to properly encrypt, transcode, and decrypt data.

Some previous methods which were efficient in terms of encryptions and decryptions; however these methods required the transcoder to implement the M-Card interface, which includes both hardware and software components. STB configuration 700 is able to decrease the number of encryptions and decryptions needed by one without moving the M-Card interface to the transcoder. For other cases when the encrypted content and keys are delivered directly to the host media processor from a content provider (there is no M-Card), the transcoder was previously required to implement a full DRM client with all of the associated DRM interfaces including key management and IP rights processing. STB configuration 1100 is able to decrease the number of encryptions and decryptions needed by one without moving a full DRM client to the transcoder.

Another benefit of STB configuration 700 is that the transcoder is not required to implement the M-Card interface. In previous methods the transcoder was required to implement the M-Card interface, which includes has both hardware and software components.

The foregoing description of various preferred embodiments of non-limiting example embodiments have been presented for purposes of illustration and description. It is not intended to be exhaustive or to limit the non-limiting example embodiments to the precise forms disclosed, and obviously many modifications and variations are possible in light of the above teaching. The example embodiments, as described above, were chosen and described in order to best explain the principles of non-limiting example embodiments and their practical application to thereby enable others skilled in the art to best utilize non-limiting example embodiments in various embodiments and with various modifications as are suited to the particular use contemplated. It is intended that the scope of non-limiting example embodiments be defined by the claims appended hereto.

1. A system for use with secure content in a first format and a key, said system comprising:
a media processor operable to obtain the key;
a transcoder operable to receive the secure content, to receive the key from said media processor, to decrypt the secure content with the key and to generate decrypted content based on the secure content; and
a transcoding device operable to transcode the decrypted content into transcoded content of a second format,
wherein said transcoder is operable to obtain a re-encryption key from said media processor, and
wherein said transcoder is further operable to encrypt the transcoded content into encrypted transcoded content using the re-encryption key.

2. The system of claim 1,
wherein said media processor is operable to decrypt the encrypted transcoded content using the re-encryption key.

3. The system of claim 2,
wherein said transcoder includes a decryption portion and an encryption portion,
wherein said decryption portion is operable to receive the secure content and the key and is operable to generate decrypted content based on the secure content,
wherein said encryption portion is operable to receive the transcoded content and is operable to encrypt the transcoded content into encrypted transcoded content using the re-encryption key.

4. The system of claim 2, wherein said transcoder is operable to obtain the re-encryption key based on IP rights associated with the secure content.

5. The system of claim 1,
wherein said transcoder is operable encrypt the transcoded content into encrypted transcoded content using the key, and
wherein said media processor is operable to decrypt the encrypted transcoded content using the key.

6. The system of claim 5,
wherein said transcoder includes a decryption portion and an encryption portion,
wherein said decryption portion is operable to receive the secure content and the key and is operable to generate decrypted content based on the secure content,
wherein said encryption portion is operable to receive the transcoded content and is operable to encrypt the transcoded content into encrypted transcoded content using the key.

7. The system of claim 1,
wherein said transcoder includes a decryption portion and an encryption portion,
wherein said decryption portion is operable to receive the secure content and the key and is operable to generate decrypted content based on the secure content,
wherein said encryption portion is operable to receive the transcoded content and is operable to encrypt the transcoded content into encrypted transcoded content.

8. The system of claim 1, wherein said media processor is operable to decrypt the encrypted transcoded content.

9. The system of claim 1, wherein said media processor is operable to receive the secure content from a conditional access device.

10. The system of claim 9,
wherein said conditional access device comprises a content server, and
wherein said conditional access device and said transcoder are separate devices.

11. A method of using secure content in a first format and a key, said method comprising:
obtaining, via a media processor, the key;
obtaining, via the transcoder, a re-encryption key;
receiving, via a transcoder, the secure content;
receiving, via the transcoder, the key from the media processor;
decrypting, via the transcoder, the secure content with the key;
generating, via the transcoder, decrypted content based on the secure content;
transcoding, via a transcoding device, the decrypted content into transcoded content of a second format; and
encrypting, via the transcoder, the transcoded content into encrypted transcoded content using the re-encryption key; and
decrypting, via the media processor, the encrypted transcoded content.

12. The method of claim 11, further comprising:
decrypting, via the media processor, the encrypted transcoded content using the re-encryption key.

13. The method of claim 12,
wherein said receiving, via a transcoder, the secure content and the key comprises receiving, via a decryption portion, the secure content and the key,
wherein said generating, via the transcoder, decrypted content based on the secure content comprises generating, via the decryption portion, decrypted content based on the secure content,
wherein said encrypting, via the transcoder, the transcoded content into encrypted transcoded content comprises receiving, via an encryption portion, the transcoded content and encrypting the transcoded content into encrypted transcoded content using the re-encryption key.

14. The method of claim 12, wherein said obtaining, via the transcoder, a re-encryption key comprises obtaining the re-encryption key based on IP rights associated with the secure content.

15. The method of claim 11, further comprising:
decrypting, via the media processor, the encrypted transcoded content,
wherein said encrypting, via the transcoder, the transcoded content into encrypted transcoded content comprises encrypting, via the transcoder, the transcoded content into encrypted transcoded content using the key, and
wherein said decrypting, via the media processor, the encrypted transcoded content comprises decrypting, via the media processor, the encrypted transcoded content using the key.

16. The method of claim 15,
wherein said receiving, via a transcoder, the secure content and the key comprises receiving, via a decryption portion, the secure content and the key,
wherein said generating, via the transcoder, decrypted content based on the secure content comprises generating, via the decryption portion, decrypted content based on the secure content,
wherein said encrypting, via the transcoder, the transcoded content into encrypted transcoded content comprises receiving, via an encryption portion, the transcoded content and encrypting the transcoded content into encrypted transcoded content using the key.

17. The method of claim 11,
wherein said receiving, via a transcoder, the secure content and the key comprises receiving, via a decryption portion, the secure content and the key,
wherein said generating, via the transcoder, decrypted content based on the secure content comprises generating, via the decryption portion, decrypted content based on the secure content,
wherein said encrypting, via the transcoder, the transcoded content into encrypted transcoded content comprises receiving, via an encryption portion, the transcoded content and encrypting the transcoded content into encrypted transcoded content.

18. The method of claim 11, further comprising decrypting, via the media processor, the encrypted transcoded content.

19. The method of claim 11, further comprising:
saving, via the media processor, the encrypted transcoded content,
wherein said decrypting, via the media processor, the encrypted transcoded content comprises decrypting, via the media processor, the encrypted transcoded content with more than one key.

20. The system of claim 11, further comprising receiving, via the media processor, the secure content from a conditional access device.

21. The system of claim 20,
wherein said receiving, via the media processor, the secure content from a conditional access device comprises receiving, via the media processor, the secure content from a content server, and
wherein the conditional access device and the transcoder are separate devices.

22. A non-transient, tangible computer-readable media having computer-readable instructions stored thereon, the computer-readable instructions being capable of being read by a computer to be used with secure content in a first format and a key, the computer-readable instructions being capable of instructing the computer to perform the method comprising:
obtaining, via a media processor, the key;
receiving, via a transcoder, the secure content;
receiving, via the transcoder, the key from the media processor;
decrypting, via the transcoder, the secure content with the key;
generating, via the transcoder, decrypted content based on the secure content;
transcoding, via a transcoding device, the decrypted content into transcoded content of a second format; and
encrypting, via the transcoder, the transcoded content into encrypted transcoded content.

23. The non-transient, tangible computer-readable media of claim 22, the computer-readable instructions being capable of instructing the computer to perform said method further comprising:
obtaining, via the transcoder, a re-encryption key; and
decrypting, via the media processor, the encrypted transcoded content using the re-encryption key,
wherein said encrypting, via the transcoder, the transcoded content into encrypted transcoded content comprises encrypting the transcoded content into encrypted transcoded content using the re-encryption key.

24. The non-transient, tangible computer-readable media of claim 22, the computer-readable instructions being capable of instructing the computer to perform said method
wherein said encrypting, via the transcoder, the transcoded content into encrypted transcoded content comprises encrypting, via the transcoder, the transcoded content into encrypted transcoded content using the key, and
wherein said decrypting, via the media processor, the encrypted transcoded content comprises decrypting, via the media processor, the encrypted transcoded content using the key.

25. The non-transient, tangible computer-readable media of claim 22, the computer-readable instructions being capable of instructing the computer to perform said method further comprising decrypting, via the media processor, the encrypted transcoded content.
